(19) United States
(12) Patent Application Publication
(10) Pub. No.: US 2025/0194779 A1
(43) Pub. Date: Jun. 19, 2025

(54) HARNESS HAVING AN EXTENSION PLATE

(71) Applicant: HUSQVARNA AB, Huskvarna (SE)

(72) Inventors: Martin JOHANSSON, Jonkoping (SE); Bjorn ALVTEGEN, Undersaker (SE)

(21) Appl. No.: 18/846,256

(22) PCT Filed: Mar. 16, 2023
(86) PCT No.: PCT/EP2023/056742

§ 371 Date: Sep. 12, 2024

(30) Foreign Application Priority Data
Mar. 23, 2022 (SE) 2250359-3

(51) Int. Cl. A45F 3/14; A45F 3/00

(52) U.S. Cl. CPC A45F 3/14; A45F 2003/003; A45F 2003/146

(57) ABSTRACT

A harness (200) for carrying outdoor power equipment may include aback plate (210), an extension plate (270) removably operably coupled to the back plate (210), a joint plate (220) configured to pivotably operably couple to the extension plate (270) or the back plate (210), a shoulder strap assembly (230) operably coupled to the joint plate (220) and a belt (240) operably coupled to the back plate (210) and configured to rest proximate to a waist of an operator. The extension plate (270) may be disposable between the back plate (210) and the joint plate (220) and may be fixed relative to the back plate (210). The joint plate (220) may be configured to pivot relative to the extension plate (270) responsive to movement of the operator wearing the harness (200).

### TECHNICAL FIELD

Example embodiments generally relate to an outdoor power tool equipment harness and, more particularly, relate to an additional component for a back plate of the outdoor power tool equipment harness that can enable the harness to be worn by a wider range of users.

### BACKGROUND

Property maintenance tasks are commonly performed using various forms of outdoor power equipment that are configured for the performance of corresponding specific tasks. Some of those forms of outdoor power equipment are designed to be effective at performing the specific tasks in situations that could be relatively brief, or could take a long time including, in some cases, a full day of work. When operating outdoor power equipment for a long period of time, fatigue can play a role in the operation of the outdoor power equipment. Regardless of how long the operator uses the outdoor power equipment, it is important that the operator remains able to effectively maneuver the outdoor power equipment device to achieve the best possible results for the property maintenance tasks.

To help reduce the speed and severity of the onset of fatigue, operators may wear a harness that may better distribute the force felt by the operator from the weight of the outdoor power equipment. However, the fitment of the harness may determine the effectiveness of the harness at minimizing fatigue. The harness may not be one-size-fits-all, and for operators that are on the larger of the extreme ends of the spectrum of operator size, the traditional harness may be an inadequate solution. Thus, an adaptation for further adjustment of the harness is necessary in many cases.

### BRIEF SUMMARY OF SOME EXAMPLES

Some example embodiments may provide for a harness for carrying outdoor power equipment. The harness may include a back plate, an extension plate removably operably coupled to the back plate, a joint plate configured to pivotably operably couple to the extension plate or the back plate, a shoulder strap assembly operably coupled to the joint plate and a belt operably coupled to the back plate and configured to rest proximate to a waist of an operator. The extension plate may be disposable between the back plate and the joint plate and may be fixed relative to the back plate. The joint plate may be configured to pivot relative to the extension plate responsive to movement of the operator wearing the harness.

Some other examples may provide for an extension plate for a harness for operating outdoor power equipment. The extension plate may include a base portion, a first retention clip that may be formed in the base portion and may be configured to operably couple the extension plate to a back plate of the harness, a second retention clip that may be formed in the base portion and may be configured to operably couple the extension plate to the back plate, and an extended retention orifice that may be formed in the base portion and may be axially aligned with the first and second retention clips. The extension plate may be fixed relative to the back plate when the extension plate may be operably coupled to the back plate. The first and second retention clips may be axially aligned along a longitudinal axis of the extension plate.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a rear view of a harness prior to addition of an extension plate of an example embodiment;

FIG. 2 illustrates a schematic block diagram of a harness in accordance with an example embodiment;

FIG. 3A illustrates a front view of a back plate of the harness in accordance with an example embodiment;

FIG. 3B illustrates a back view of the back plate of the harness in accordance with an example embodiment;

FIG. 3C illustrates an isometric view of the back plate of the harness in accordance with an example embodiment;

FIG. 4A illustrates a front view of an extension plate for the harness in accordance with an example embodiment;

FIG. 4B illustrates a rear view of the extension plate for the harness in accordance with an example embodiment;

FIG. 4C illustrates an isometric view of the extension plate for the harness in accordance with an example embodiment;

FIG. 5 illustrates an exploded isometric view of the extension plate and back plate in accordance with an example embodiment;

FIG. 6 illustrates a close up isometric view of a retention orifice in accordance with an example embodiment;

FIG. 7 illustrates a close up isometric view of a retention clip in accordance with an example embodiment; and

FIG. 8 illustrates a front view of a pivotable retention clip in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

In some example embodiments, an operator may wear a harness while actively operating outdoor power equipment. The harness may be utilized for operably coupling to outdoor power equipment that may be too heavy or otherwise cumbersome to effectively operate for extended periods of time. The harness may include at least one leg plate, hip pad or other contact pad structure that may separate the outdoor power equipment device from direct physical contact with the operator. Furthermore, the nature of performing lawn care and maintenance tasks may often imply that anyone should be able to operate the outdoor power equipment, regardless of the operator's physical size and strength. In this regard, a standard harness may not properly fit all potential operators of the outdoor power equipment, even with a range of sizes built into the standard harness. As such, it may be desirable to expand the range of sizes of the harness so that operators that may exceed the range of sizes may still wear the harness when operating outdoor power equipment. Thus, creating an extension plate for the harness may allow more operators to effectively and comfortably operate outdoor power equipment for extended periods of time while minimizing the onset of fatigue from carrying the outdoor power equipment device. Other improvements may also be possible, and the improvements can be made completely independent of each other, or in combination with each other in any desirable configuration. Accordingly, the operability and utility of the harness may be enhanced or otherwise facilitated.

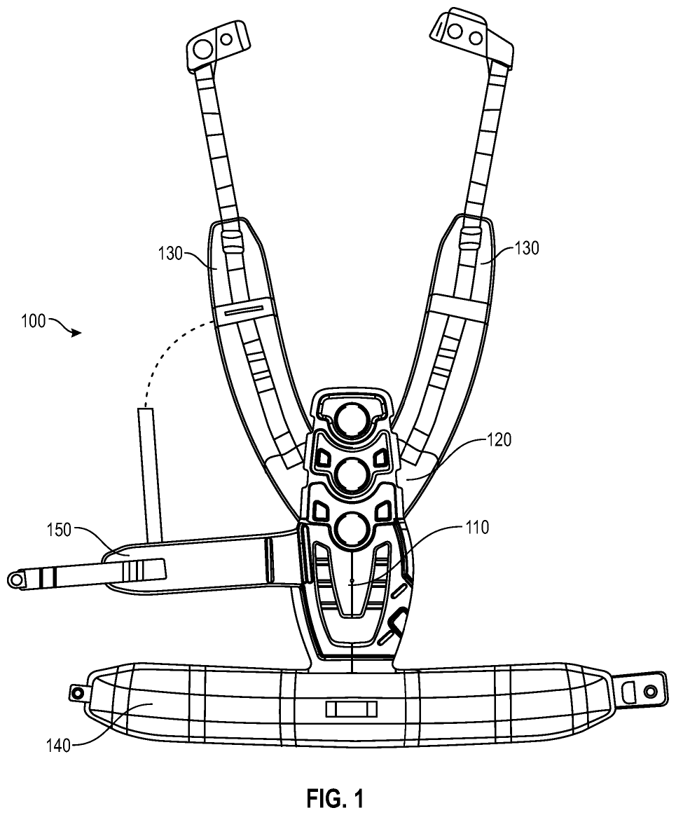

FIG. 1 is a rear view of a harness 100 prior to addition of the extension plate mentioned above. As shown in FIG. 1, the harness 100 may include a back plate 110, a joint plate 120, a shoulder strap assembly 130, a belt 140, and a side strap 150. The back plate 110 may be centrally located relative to the other components of the harness 100 such that the back plate 110 may serve as a base to which the other components may be operably coupled. The back plate 110 may also play an integral role in supporting the operator's back when the harness 100 is being worn and an outdoor power equipment device is in use. The joint plate 120 may operably couple the back plate 110 to the shoulder strap assembly 130. Accordingly, the shoulder strap assembly 130 may be configured to extend around, and rest on top of, an operator's shoulders. The joint plate 120 may give the operator the ability to move in a full range of motion by pivotably operably coupling the shoulder strap assembly 130 to the back plate 110. In this regard, as the operator wears the harness 100 and operates the outdoor power equipment device, the operator's shoulders may move responsive to moving the device. The pivotable operable coupling between the joint plate 120 and the back plate 110 allows the operator to make such movements without the harness 100 restricting the operator and also without the harness 100 coming off the operator. In some embodiments, it may be possible to adjust the positon at which the joint plate 120 operably couples to the back plate 110 which may accordingly alter the effective size of the harness 100.

The back plate 110 may also be operably coupled to the belt 140. The belt 140 may be configured to secure to an operator's waist when the operator is wearing the harness 100. In this regard, the belt 140 may distribute some of the load force from the weight of the outdoor power equipment off of the operator's shoulders, so as to minimize the onset of operator fatigue when using the outdoor power equipment for an extended period of time. The back plate 110 may also be operably coupled to the side strap 150 which may be configured to operably couple to the outdoor power equipment device directly or indirectly (e.g., via a hook assembly). In some embodiments, the side strap 150 may also be operably coupled to the leg plate, hip pad or other contact pad structure so that the outdoor power equipment device is separated from direct contact with the operator.

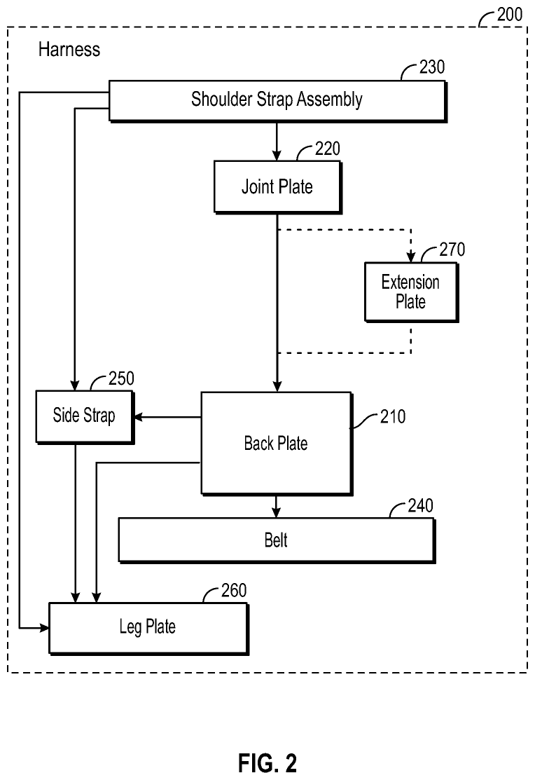

FIG. 2 illustrates a schematic block diagram of a harness 200 in accordance with an example embodiment. The harness 100 detailed in FIG. 1 may be an example of the harness 200 described herein. As shown in FIG. 2, the harness 200 may include a back plate 210, a joint plate 220, a shoulder strap assembly 230, a belt 240, and a side strap 250, which may have similar structure and function as the components described in reference to FIG. 1 above. The harness 200 may also include a leg plate 260 which may be operably coupled to both the back plate 210 and the side strap 250. In some embodiments, the leg plate 260 may be configured to rest along a side of the operator to provide a padded barrier between the outdoor power equipment device and the operator, and may have a hook or other device for supporting the outdoor power equipment. In this regard, the operator may have additional protection from the outdoor power equipment, especially for an extended period of time.

The harness 200 may also include an extension plate 270. As mentioned above, the size of the harness 200 may be adjusted by changing the position at which the joint plate 220 operably couples to the back plate 210. However, in some embodiments, the back plate 210 may not include an ideal position for the joint plate to operably couple to the back plate 210 for larger operators. Rather than have an entirely different harness 200 for larger operators to wear, the extension plate 270 of some embodiments may provide the harness 200 with the ability to be adjusted to a size larger than the largest size possible on the unaltered back plate 210. The extension plate 270 may be configured to operably couple to both the back plate 210 and the joint plate 220. In this regard, the extension plate 270 may be disposed between the back plate 210 and the joint plate 220 when the extension plate 270 is installed. As such, the joint plate 220 may operably couple to the extension plate 270 in the same manner as the joint plate 220 would otherwise operably couple to the back plate 210. Further detail about the extension plate 270 and its corresponding structure and function will be described in relation to later figures below.

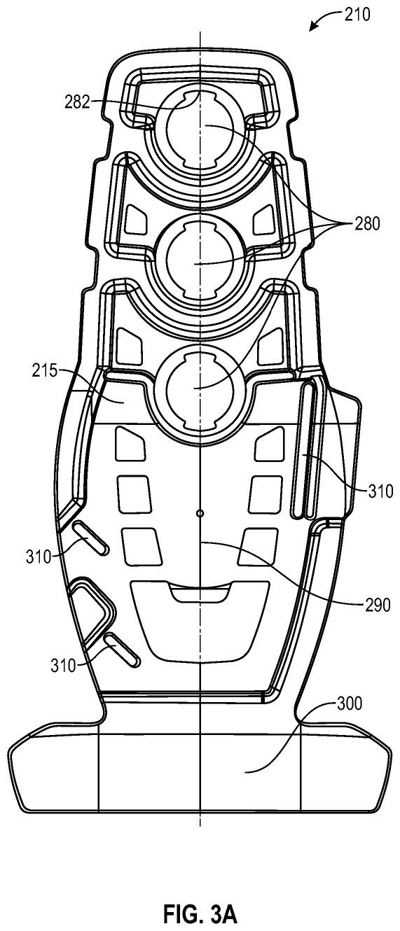

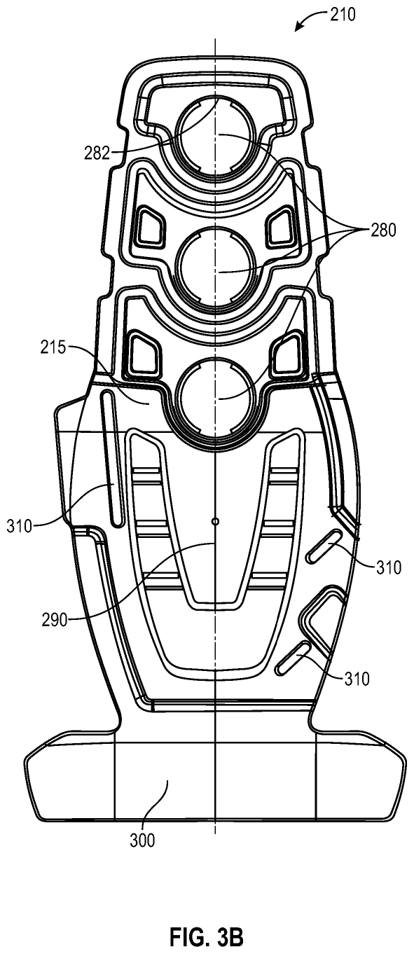

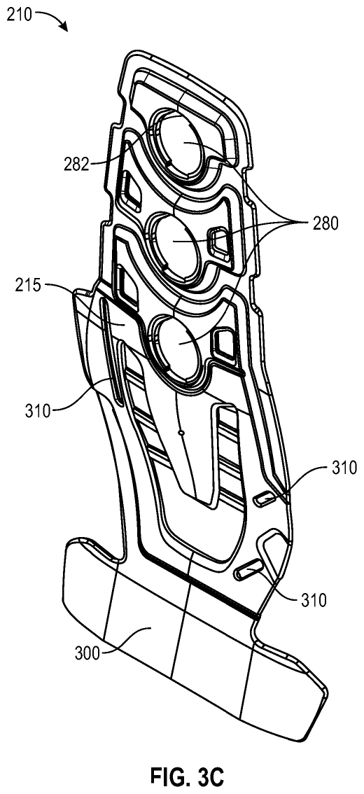

FIGS. 3A, 3B, and 3C illustrate front, rear, and isometric views of the back plate 210 of the harness 200 in accordance with an example embodiment, respectively. Referring now to FIGS. 3A, 3B, and 3C, the back plate 210 may include a plate member 215, and the plate member 215 may include a plurality of retention orifices 280. Each of the retention orifices 280 may be configured to operably couple with the extension plate 270 or with the joint plate 220. In some embodiments, the plate member 215 may include three retention orifices 280. In such cases, each retention orifice 280 may have a corresponding size (either Small, Medium, or Large) to which the harness 200 can be configured, depending on which retention orifice 280 the joint plate 220 may be operably coupled to. The retention orifices 280 may also be axially aligned along a longitudinal axis 290 of the plate member 215, and as such, the harness 200 may be centered in a middle of the operator's back in order to better distribute the weight of the outdoor power equipment device when in use. Each of the retention orifices 280 may be substantially circular in shape and may also all be the same size so as to enable the joint plate 220 or the extension plate 270 to operably couple to any of the retention orifices 280 in the same manner. In some embodiments, each retention orifice 280 may include a pair of diametrically opposed guide slots 282. The guide slots 282 may have different functions depending on whether or not the extension plate 270 is operably coupled with the retention orifice 280, or if the joint plate 220 is operably coupled with the retention orifice 280. The particular details of the guide slots 282 will be discussed later on in reference to later figures.

The plate member 215 may also include a waist portion 300 that may be configured to operably couple to the belt 240. The entire plate member 215, and particularly the waist portion 300, may be curved so that the back plate 210 conforms to the natural shape of the operator's back. In this regard, the harness 200 may provide the best possible fit for the operator and may therefore be more effective in minimizing the fatigue levels of the operator due to the extended use of the outdoor power equipment. In addition to the curvature of the plate member 215, the plate member 215 of some embodiments may also include a plurality of accessory apertures 310 to which the side strap 250 and other accessories may operably couple. The locations of the accessory apertures 310 may be determined based on the type of accessory intended to operably couple thereto so that the operator has ideal accessibility to all attachments and their respective functions. In some cases, the plate member 215 may further include a plurality of structural cutouts strategically disposed all over the back plate 210 as a method of saving weight and improving cooling of the operator without compromising on the structural integrity of the back plate 210. In some embodiments, the plate member 215 may be formed from a plastic material via an injection molding process in order to minimize manufacturing costs as well as provide a lightweight, yet strong, material to meet the specific needs of the back plate 210.

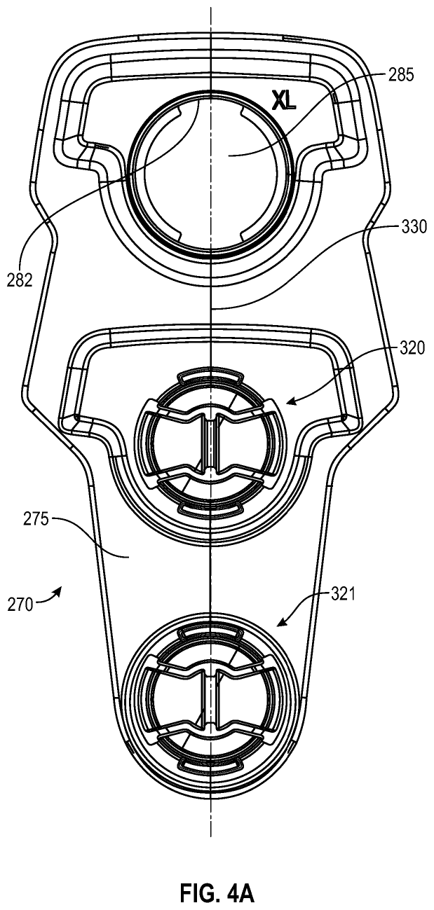

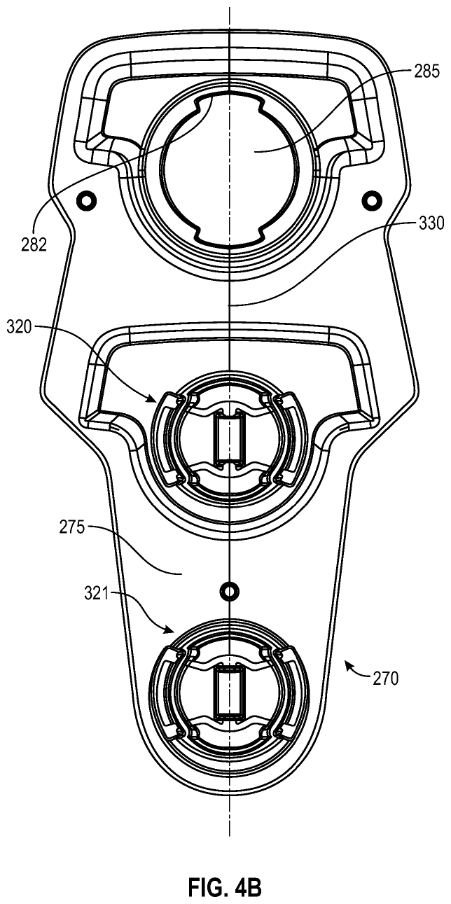

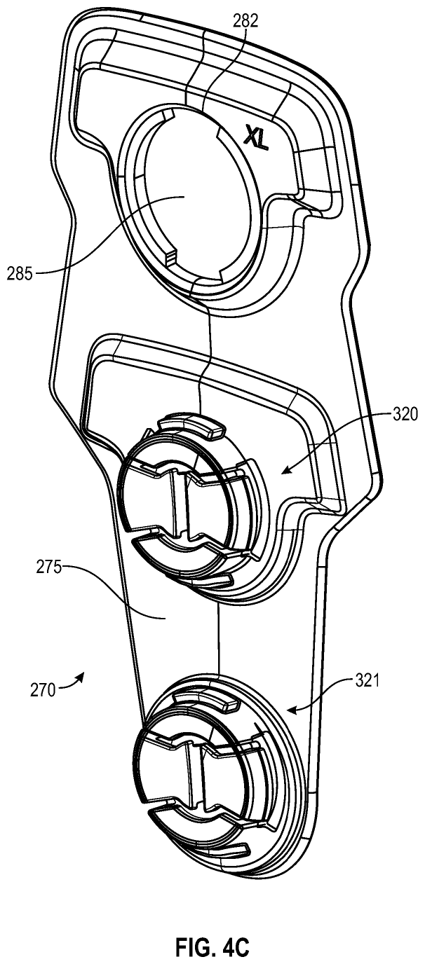

FIGS. 4A, 4B, and 4C illustrate front, rear, and isometric views of the extension plate 270 in accordance with an example embodiment, respectively. The extension plate 270 may be an individual component of the harness 200. In other words, the extension plate 270 may be formed on its own and not as an integrated part of the back plate 210. The extension plate 270 may include a base portion 275, and the base portion 275 may include at least one extended retention orifice 285 and at least one retention clip. In some embodiments, the base portion 275 may include a first retention clip 320 and a second retention clip 321, which may each be axially aligned with the extended retention orifice 285 along a longitudinal axis 330 of the extension plate 270. In some cases, the extended retention orifice 285 may be structurally identical to the retention orifices 280 disposed on the back plate 210. In this regard, the extended retention orifice 285 may be substantially circular in shape, and may also include the pair of diametrically opposed guide slots 282. When the extension plate 270 is operably coupled to the back plate 210, the extended retention orifice 285 may be axially aligned with the retention orifices 280 along the longitudinal axis 290 of the back plate 210 as well as disposed beyond an end of the back plate 210 opposite the waist portion 300. In some embodiments, the extension plate 270 may be formed from a plastic material via an injection molding process in order to minimize manufacturing costs as well as to provide a lightweight, yet strong, material to meet the specific needs of the extension plate 210.

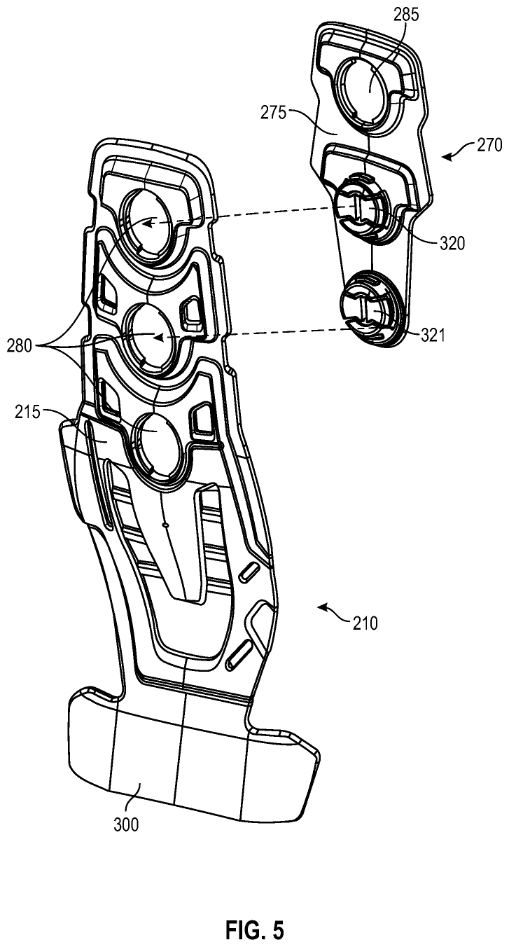

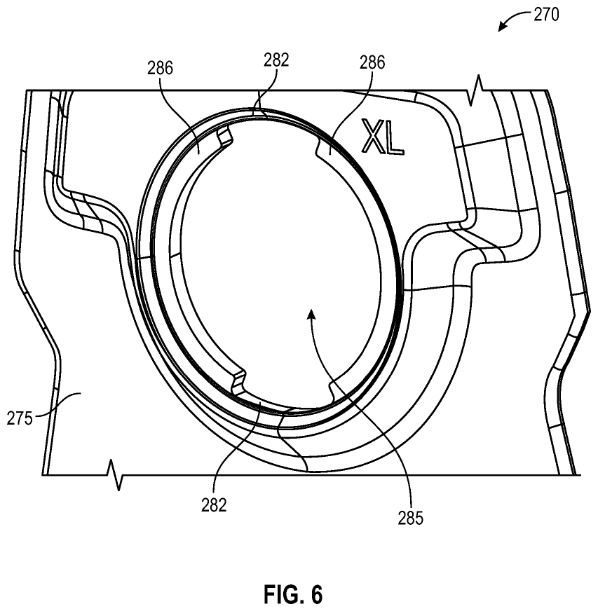

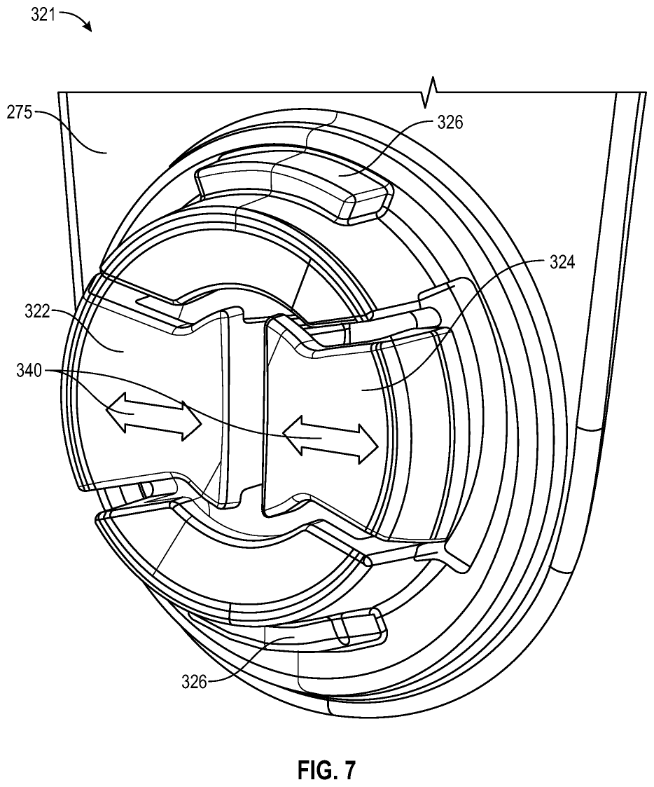

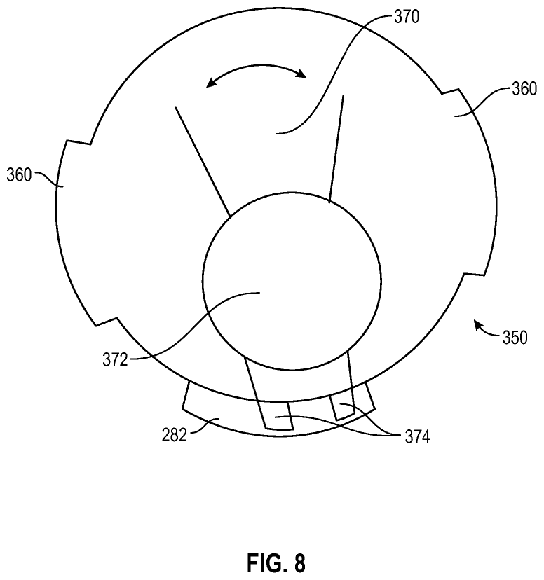

Referring now to FIGS. 5-8, the first retention clip 320 and the second retention clip 321 may be configured to operably couple with the retention orifices 280 of the back plate 210. In some embodiments, the first and second retention clips 320 and 321 may be configured to operably couple to two consecutive retention orifices 280 that are most distant from the waist portion 300 of the back plate 210. As such, the extension plate 270 may be configured to operably couple at a top of the back plate 210 so that the extended retention orifice 285 extends beyond an end (e.g., a top end) of the back plate 210. In this regard, the extended retention orifice 285 may provide an additional larger size setting (e.g. Extra Large) to which the joint plate 220 may operably couple in order to provide the best fit for the operator wearing the harness 200.

In some embodiments, the first and second retention clips 320 and 321 may be configured to operably couple to the retention orifices 280 via a snap fit. In this regard, the first and second retention clips 320 and 321 may each include a first clip member 322, a second clip member 324, and a pair of diametrically opposed guide protrusions 326. The diametrically opposed guide protrusions 326 may be configured to align with the guide slots 282 of each retention orifice 280. When the guide protrusions 326 align with the guide slots 282, the first and second retention clips 320 and 321 may be inserted into the retention orifices 280. In this regard, the first clip member 322 and the second clip member 324 may be forced towards each other (in the direction of arrows 340) responsive to the first and second retention clips 320 and 321 being pushed past a retention lip 286 of the retention orifice 280. Responsive to the first clip member 322 and the second clip member 324 passing the retention lip 286, the first clip member 322 and the second clip member 324 may be biased away from each other, and the first and second retention clips 320 and 321 may accordingly snap into their operable coupling with the retention lip 286 in the retention orifice 280. In this regard, due to the alignment of the guide protrusions 326 in the guide slots 282, the first and second retention clips 320 and 321 may not rotate with respect to their respective retention orifice 280 responsive to being operably coupled thereto.

As mentioned above, the joint plate 220 may be configured to pivotably operably couple to the back plate 210 or to the extension plate 270. In this regard, the joint plate 220 may include a pivotable retention clip 350. The pivotable retention clip 350 may be configured to operably couple with any of the retention orifices 280 of the back plate 210, or to the extended retention orifice 285 of the extension plate 270. As such, the pivotable retention clip 350 may include guide members 360 which, similar to the guide protrusions 326, may be configured to align with guide slots 282 so that the pivotable retention clip 350 may be pushed into the retention orifice 280 or the extended retention orifice 285. Responsive to the pivotable retention clip 350 being inserted in the retention orifice 280 or the extended retention orifice 285, the guide members 360 may clear the retention lip 286, such that the pivotable retention clip 350 may then rotate and the guide members 360 may slide along the retention lip 286. In some embodiments, the pivotable retention clip 350 may further include a locking member 370. The locking member 370 may include a release button 372 and a locking arm 374. In some embodiments, the locking member 370 may be biased upward into a locked position that the locking member 370 assumes when no outside forces are present. Applying a force to either the release button 372 or to the locking arm 374 may depress the locking member 370 out of the locked position and into an unlocked position. In some embodiments, the locking arm 374 may be disposed roughly halfway between the diametrically opposed guide members 360, on a perimeter of the pivotable retention clip 350.

The locking member 370 may be forced into the unlocked position responsive to the pivotable retention clip 350 being inserted into the retention orifice 280 or the extended retention orifice 285 by the retention lip 286 applying a force to the locking arm 374. Accordingly, responsive to the pivotable retention clip 350 being rotated within the retention orifice 280 or the extended retention orifice 285, the locking arm 374 may align with one of the guide slots 282, which may then allow the locking member 370 to release from the unlocked position and snap into the locked position due to the biasing force of the locking member 370. As such, the locking arm 374 may be confined to an area defined by the guide slot 282. Accordingly, the pivotable operable coupling of the joint plate 220 to the back plate 210 or to the extension plate 270 may be complete. The pivotable retention clip 350 may be configured to pivot relative to the back plate 210 or to the extension plate 270 within the operable coupling to the retention orifice 280 or the extended retention orifice 285. In some embodiments, the locking arm 374 may not move outside of the area defined by the guide slot 282 unless a force is applied to the release button 372 or to the locking arm 374 to depress the locking arm 374 below the retention lip 286. Thus, the guide slot 282 may therefore define a range of possible pivot angles for the pivotable retention clip 350.

Some example embodiments may provide for a harness for carrying outdoor power equipment. The harness may include a back plate, an extension plate removably operably coupled to the back plate, a joint plate configured to pivotably operably couple to the extension plate or the back plate, a shoulder strap assembly operably coupled to the joint plate and a belt operably coupled to the back plate and configured to rest proximate to a waist of an operator. The extension plate may be disposable between the back plate and the joint plate and may be fixed relative to the back plate. The joint plate may be configured to pivot relative to the extension plate responsive to movement of the operator wearing the harness.

The harness of some embodiments may include additional features, modifications, augmentations and/or the like to achieve further objectives or enhance performance of the harness. The additional features, modifications, augmentations and/or the like may be added in any combination with each other. Below is a list of various additional features, modifications, and augmentations that can each be added individually or in any combination with each other. For example, the harness may further include a leg plate which may be operably coupled to the harness and may be configured to support an outdoor power equipment device. In an example embodiment, the back plate may include a plate member with at least three retention orifices formed therein. In some cases, each retention orifice may correspond to a different size of the harness. In an example embodiment, the joint plate and the extension plate may each be configured to operably couple to the retention orifices. In some cases, each retention orifice may be substantially circular in shape. In an example embodiment, each retention orifice may include a pair of diametrically opposed guide slots centered along a longitudinal axis of the back plate. In some cases, the extension plate may include a base portion, a first retention clip and a second retention clip. In an example embodiment, the first and second retention clips may be configured to operably couple with the retention orifices in the back plate. In some cases, the first and second retention clips may each include a pair of diametrically opposed guide protrusions that may align with the diametrically opposed guide slots of the retention orifices. In an example embodiment, the first and second retention clips may be configured to operably couple to respective ones of the retention orifices of the back plate via snap fits. In some cases, the extension plate may further include an extended retention orifice which may be axially aligned with the first and second retention clips. In an example embodiment, the extended retention orifice may be axially aligned along a longitudinal axis of the back plate when the extension plate may be operably coupled to the back plate. In some cases, the joint plate may be configured to pivotably operably couple to one of the retention orifices on the back plate, or to the extended retention orifice when the extension plate may operably coupled to the back plate. In an example embodiment, the joint plate may include a pivotable retention clip. In some cases, the pivotable retention clip may include a pair of diametrically opposed guide members and a locking member which may be disposed on a perimeter of the pivotable retention clip between the guide members. In an example embodiment, the guide members may be configured to align with the guide slots of the retention orifices before the pivotable retention clip may be operably coupled with the retention orifice, and may be configured to misalign with the guide slots after the pivotable retention clip may be operably coupled with the retention orifice. In some cases, the locking member may be biased into a locked state responsive to the pivotable retention clip operably coupling with the retention orifice and the locking member aligning with one of the guide slots. In an example embodiment, the guide slot may restrict the motion of the pivotable retention clip responsive to the locking member entering the locked state. In some cases, the locking member may be configured to enter an unlocked state responsive to a force provided by the operator.

Some other examples may provide for an extension plate for a harness for operating outdoor power equipment. The extension plate may include a base portion, a first retention clip that may be formed in the base portion and may be configured to operably couple the extension plate to a back plate of the harness, a second retention clip that may be formed in the base portion and may be configured to operably couple the extension plate to the back plate, and an extended retention orifice that may be formed in the base portion and may be axially aligned with the first and second retention clips. The extension plate may be fixed relative to the back plate when the extension plate may be operably coupled to the back plate. The first and second retention clips may be axially aligned along a longitudinal axis of the extension plate.

The extension plate of some embodiments may include additional features, modifications, augmentations and/or the like to achieve further objectives or enhance performance of the harness. The additional features, modifications, augmentations and/or the like may be added in any combination with each other. Below is a list of various additional features, modifications, and augmentations that can each be added individually or in any combination with each other. For example, a joint plate may be configured to pivotably operably couple to the harness via the extension plate. In an example embodiment, the extension plate may be configured to operably couple to the back plate. In some cases, the back plate may include a plate member with at least three retention orifices formed therein. In an example embodiment, each retention orifice may correspond to a different size of the harness. In some cases, each retention orifice may include a pair of diametrically opposed guide slots which may be centered along a longitudinal axis of the back plate. In an example embodiment, the first and second retention clips may be configured to operably couple with respective ones of the retention orifices. In some cases, the first and second retention clips may each comprise a pair of diametrically opposed guide protrusions that may be configured to align with the guide slots. In an example embodiment, the first and second retention clips may be configured to operably couple to respective ones of the retention orifices via snap fits. In some cases, the extension plate may further include an extended retention orifice that may be axially aligned with the first and second retention clips. In an example embodiment, the extended retention orifice may be axially aligned along the longitudinal axis of the back plate when the extension plate may be operably coupled to the back plate. In some cases, the joint plate may be configured to pivotably operably couple to the extension plate at the extended retention orifice. In an example embodiment, the joint plate may be configured to operably couple to the extension plate via a pivotable retention clip. In some cases, the pivotable retention clip may include a pair of diametrically opposed guide members and a locking member that may be disposed on a perimeter of the pivotable retention clip between the guide members. In an example embodiment, the guide members of the pivotable retention clip may be configured to align with the guide slots of the extended retention orifice before the joint plate may be operably coupled with the extension plate, and may be configured to misalign with the guide slots after the joint plate may be operably coupled with the extension plate. In some cases, the locking member may be biased into a locked state responsive to the joint plate operably coupling with the extension plate and the locking member aligning with one of the guide slots. In an example embodiment, the locking member may restrict the motion of the pivotable retention clip responsive to entering the locked state. In some cases, the locking member may be configured to enter an unlocked state responsive to receiving a force.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A harness for carrying outdoor power equipment, the harness comprising:
a back plate;
an extension plate removably operably coupled to the back plate;
a joint plate configured to pivotably operably couple to the extension plate or the back plate;
a shoulder strap assembly operably coupled to the joint plate; and
a belt operably coupled to the back plate and configured to rest proximate to a waist of an operator,
wherein the extension plate is disposable between the back plate and the joint plate to be fixed relative to the back plate, and
wherein the joint plate is configured to pivot relative to the extension plate responsive to movement of the operator wearing the harness.

2. The harness of claim 1, further comprising a leg plate operably coupled to the harness and configured to support an outdoor power equipment device.

3. The harness of claim 1, wherein the back plate comprises a plate member with at least three retention orifices formed therein,
wherein each retention orifice corresponds to a different size of the harness, and
wherein the joint plate and the extension plate are each configured to operably couple to the retention orifices.

4. The harness of claim 3, wherein each retention orifice is substantially circular in shape,
wherein each retention orifice comprises a pair of diametrically opposed guide slots centered along a longitudinal axis of the back plate.

5. The harness of claim 4, wherein the extension plate comprises a base portion, a first retention clip and a second retention clip, the first and second retention clips being configured to operably couple with the retention orifices in the back plate, and
wherein the first and second retention clips each comprise a pair of diametrically opposed guide protrusions that align with the diametrically opposed guide slots of the retention orifices.

6. The harness of claim 5, wherein the first and second retention clips are configured to operably couple to respective ones of the retention orifices of the back plate via snap fits.

7. The harness of claim 5, wherein the extension plate further comprises an extended retention orifice axially aligned with the first and second retention clips.

8. The harness of claim 7, wherein the extended retention orifice is axially aligned along the longitudinal axis of the back plate when the extension plate is operably coupled to the back plate.

9. The harness of claim 8, wherein the joint plate is configured to pivotably operably couple to one of the retention orifices on the back plate, or to the extended retention orifice when the extension plate is operably coupled to the back plate.

10. The harness of claim 9, wherein the joint plate comprises a pivotable retention clip, the pivotable retention clip comprising:
a pair of diametrically opposed guide members; and
a locking member disposed on a perimeter of the pivotable retention clip between the guide members,
wherein the guide members are configured to align with the guide slots of the retention orifices before the pivotable retention clip is operably coupled with the retention orifice, and misalign with the guide slots after the pivotable retention clip is operably coupled with the retention orifice,
wherein the locking member is biased into a locked state responsive to the pivotable retention clip operably coupling with the retention orifice and the locking member aligning with one of the guide slots,
wherein the guide slot restricts the motion of the pivotable retention clip responsive to the locking member entering the locked state, and
wherein the locking member is configured to enter an unlocked state responsive to a force provided by the operator.

11. An extension plate for a harness for operating outdoor power equipment, the extension plate comprising:
a base portion;
a first retention clip formed in the base portion and configured to operably couple the extension plate to a back plate of the harness;
a second retention clip formed in the base portion and configured to operably couple the extension plate to the back plate; and
an extended retention orifice formed in the base portion and axially aligned with the first and second retention clips,
wherein the extension plate is fixed relative to the back plate when the extension plate is operably coupled to the back plate, and
wherein the first and second retention clips are axially aligned along a longitudinal axis of the extension plate.

12. The extension plate of claim 11, wherein a joint plate is configured to pivotably operably couple to the harness via the extension plate.

13. The extension plate of claim 12, wherein the extension plate is configured to operably couple to the back plate,
wherein the back plate comprises a plate member with at least three retention orifices formed therein,
wherein each retention orifice corresponds to a different size of the harness, and
wherein each retention orifice comprises a pair of diametrically opposed guide slots centered along a longitudinal axis of the back plate.

14. The extension plate of claim 13, wherein the first and second retention clips are configured to operably couple with respective ones of the retention orifices, and
wherein the first and second retention clips each comprise a pair of diametrically opposed guide protrusions configured to align with the guide slots.

15. The extension plate of claim 14, wherein the first and second retention clips are configured to operably couple to respective ones of the retention orifices via snap fits.

16. The extension plate of claim 14, wherein the extension plate further comprises an extended retention orifice axially aligned with the first and second retention clips.

17. The extension plate of claim 16, wherein the extended retention orifice is axially aligned along the longitudinal axis of the back plate when the extension plate is operably coupled to the back plate.

18. The extension plate of claim 17, wherein the joint plate is configured to pivotably operably couple to the extension plate at the extended retention orifice.

19. The extension plate of claim 18, wherein the joint plate is configured to operably couple to the extension plate via a pivotable retention clip the pivotable retention clip comprising:
a pair of diametrically opposed guide members; and
a locking member disposed on a perimeter of the pivotable retention clip between the guide members.

20. The extension plate of claim 19, wherein the guide members of the pivotable retention clip are configured to align with the guide slots of the extended retention orifice before the joint plate is operably coupled with the extension plate, and misalign with the guide slots after the joint plate is operably coupled with the extension plate,
wherein the locking member is biased into a locked state responsive to the joint plate operably coupling with the extension plate and the locking member aligning with one of the guide slots,
wherein the locking member restricts the motion of the pivotable retention clip responsive to entering the locked state, and
wherein the locking member is configured to enter an unlocked state responsive to receiving a force.
